(19) United States
(12) Patent Application Publication
(10) Pub. No.: US 2013/0273498 A1
(43) Pub. Date: Oct. 17, 2013

(54) DENTAL IMPLANT

(71) Applicants: John Woods, Chalford Hill (GB); Michael Tuke, Guildford (GB); David Sinclair, Cuckfield (GB)

(72) Inventors: John Woods, Chalford Hill (GB); Michael Tuke, Guildford (GB); David Sinclair, Cuckfield (GB)

(21) Appl. No.: 13/882,847

(22) PCT Filed: Nov. 1, 2011
(86) PCT No.: PCT/GB2011/052121

§ 371 Date: Jul. 4, 2013

(30) Foreign Application Priority Data
Nov. 1, 2010 (GB) 1018408.3

(51) Int. Cl. A61C 3/00; A61C 13/08; A61C 8/00

(52) U.S. Cl. CPC A61C 3/00; A61C 8/0048; A61C 13/08
USPC 433/119; 433/172; 433/201.1

(57) ABSTRACT

A dental implant comprising an implant body which has an asymmetric root portion receivable in an asymmetric open root cavity of the patient and engagement means on the asymmetric root portion to at least in part engage a surface of the root cavity so as to prevent or inhibit unintentional extraction. The asymmetric root portion is complementarily shaped to fit the said asymmetric open root cavity, thus substantially dispensing with the need for protracted preparation of the root cavity and providing substantially immediate stability for the prosthetic tooth.

The present invention relates to a dental implant for a prosthetic tooth, a method of forming such an implant, and a method of replacing a patient's tooth using such a dental implant.

Prosthetic teeth are well known and typically comprise a dental implant, an abutment which engages with the dental implant, and a prosthetic crown which caps the abutment. However, when the original tooth is removed, the tooth cavity of the patient has to be prepared to accept a substantially symmetrical frusto-conical implant, which does not conform to the shape of the cavity left by the extracted tooth. The frusto-conical implant, because of the shape mismatch and inherent lack of stability needs time to integrate before an appropriate crown can be fitted. Traditional implants are not a good fit around the gum line and consequently the cosmetic appearance may be compromised.

The present invention seeks to provide a solution to these problems.

According to a first aspect of the invention, there is provided a dental implant for directly or indirectly supporting a prosthetic crown, the dental implant comprising an implant body having an asymmetric root portion receivable in an asymmetric open root cavity and engagement means on the asymmetric root portion for at least in part engaging a surface of the root cavity, the asymmetric root portion being complimentarily shaped to fit the said asymmetric open root cavity.

Preferable and/or optional features of the first aspect of the invention are set forth in claims 2 to 13, inclusive.

According to a second aspect of the invention, there is provided a dental implant according to the first aspect of the invention, in combination with an abutment on the base portion and which is adapted to support a prosthetic crown.

Preferable and/or optional features of the second aspect of the invention are set forth in claims 16 to 19, inclusive.

According to a third aspect of the invention, there is provided a prosthetic tooth comprising a dental implant and abutment combination in accordance with the second aspect of the invention, and a prosthetic crown on the abutment.

Preferable and/or optional features of the third aspect of the invention are set forth in claims 21 to 24, inclusive.

According to a fourth aspect of the invention, there is provided a method of forming a dental implant in accordance with the first aspect of the invention, the method comprising the steps of: forming a three-dimensional computer-generated model of a root cavity of a patient's mouth, and forming the asymmetric root portion of the dental implant to match or substantially match the said model. Preferably, the said forming is by machining, electron beam melting, ion beam melting or laser beam melting the implant material. However, any other suitable technique can also be considered.

According to a fifth aspect of the invention, there is provide a method of replacing a patient's tooth, the method comprising the steps of: inserting an asymmetric root portion of a dental implant in accordance with the first aspect of the invention into an asymmetric open root cavity of a patient's mouth, wherein the asymmetric root portion and the asymmetric open root cavity are substantially complimentarily shaped.

Preferable and/or optional features of the fifth aspect of the invention are set forth in claims 27 to 33, inclusive.

According to a sixth aspect of the invention, there is provide a dental tool for preparing an asymmetric open root cavity to receive a dental implant in accordance with the first aspect of the invention, the dental tool having an asymmetric abrasive vibratory head.

Preferable and/or optional features of the sixth aspect of the invention are set forth in claims 34 to 37, inclusive.

The present invention will now be more particularly described, by way of example only, with reference to the accompanying drawings, in which:

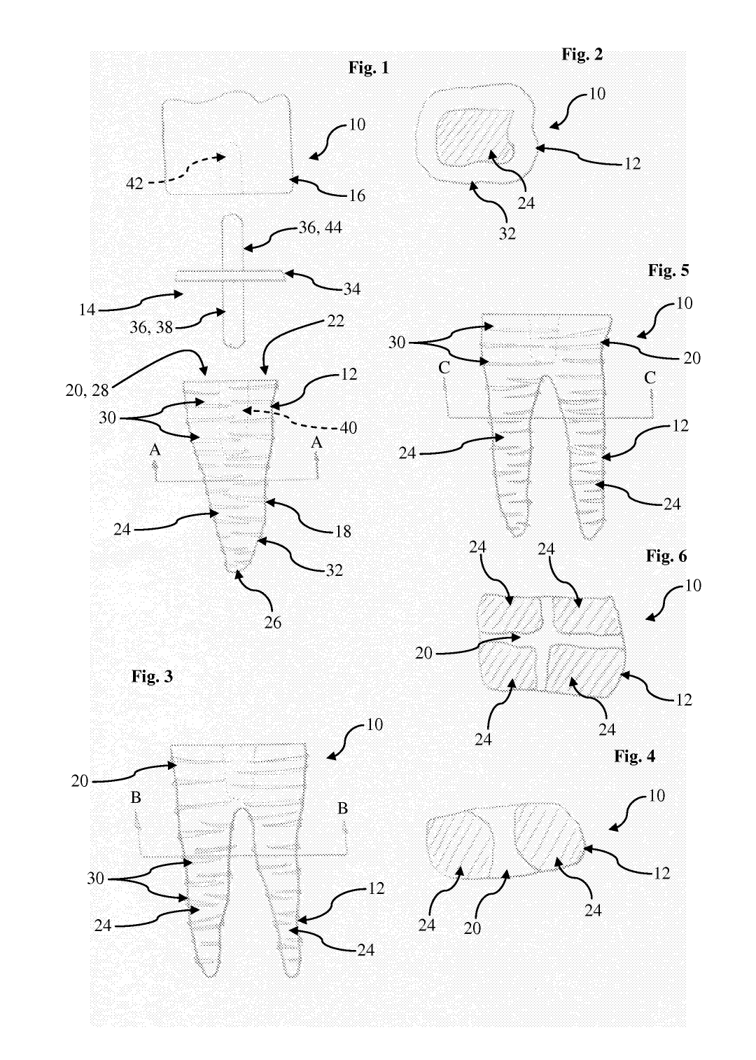

FIG. 1 is a diagrammatic exploded side elevational view of one embodiment of a prosthetic tooth in accordance with the third aspect of the invention having a first embodiment of a dental implant in accordance with the first aspect of the invention;

FIG. 2 is a lateral cross-sectional view along line A-A in FIG. 1 of an asymmetric root portion of the dental implant;

FIG. 3 is a diagrammatic side elevational view of a second embodiment of a dental implant, in accordance with the first aspect of the invention;

FIG. 4 is a lateral cross-sectional view along line B-B in FIG. 3 of the asymmetric root portion of the second embodiment of the dental implant;

FIG. 5 is a diagrammatic side elevational view of a third embodiment of a dental implant, in accordance with the first aspect of the invention; and

FIG. 6 is a lateral cross-sectional view along line C-C in FIG. 5 of an asymmetric root portion of the third embodiment of the dental implant.

Referring firstly to FIGS. 1 and 2 of the drawings, there is shown an embodiment of a prosthetic tooth 10 which comprises a dental implant 12 formed of a biocompatible material, such as titanium alloy, an abutment 14 typically also formed of a biocompatible material such as titanium alloy, and a prosthetic crown 16 which may be enamel, ceramic or any other suitably resilient material.

This first embodiment of the dental implant 12 includes a generally tapering implant body 18 which has a base portion 20 at its wide proximal end 22 and a root portion 24 which extends from the base portion 20 to the narrow and generally pointed distal end 26.

In this embodiment, a single root portion 24 is provided, and therefore the base portion 20 is a substantially planar top surface 28 at the proximal end 22 of the implant body 18 for seating the abutment 14.

The root portion 24 is asymmetric about its longitudinal axis, and is formed to be complimentary with an asymmetric open root cavity of a patient's mouth from which a typically original tooth has been removed.

In this case, the implant body 18 is also provided with a plurality of lateral projections 30 which extend from the exterior surface of the asymmetric root portion 24 along at least a majority of its longitudinal extent and around its circumference. The lateral projections 30 are spaced arcuate elongate ribs or fins. A lateral extent of the ribs or fins is substantially uniform along their longitudinal extents. However, irregular or non-uniform lateral extents can be utilised either entirely or in combination.

The lateral projections 30 may be or include pips or protuberances.

Alternatively, instead of a plurality of lateral projections 30, a single screw-thread may be provided along the exterior surface of the root portion 24. Again, a lateral dimension from root to crest of the thread may be uniform along at least a majority of its longitudinal extent, or it may be irregular or non-uniform. The crest of the thread may be non-truncated or substantially non-truncated so that the thread becomes self-broaching or self-tapping.

Equally, if a plurality of lateral projections 30 is provided as described above, such as by use of spaced ribs or fins, these projections 30 may also have non- or substantially non-truncated crests or outer edges so as to become self-broaching.

Alternatively or additionally, other engagement means can be considered, such as a rough textured exterior surface 32. The rough textured exterior surface 32 is provided on the outer surface of the root portion 24 and/or the projections 30 if provided. The rough textured exterior surface 32 may be integrally formed as one-piece on the outer surface of the root portion 24 and/or the projections 30. Optionally, the rough textured exterior surface 32 may be provided as an outer layer formed on the exterior surface of the root portion 24 and/or the projections 30. In this case, the outer layer may be a coating of suitable biocompatible material such as pure titanium or Hydroxyapetite.

The engagement means 30, 32 is suitable for at least in part broaching or rasping a cavity wall of the patient's root cavity during insertion and thus also preventing or inhibiting unintentional extraction once forced home.

To form the implant body 18, a three-dimensional computer-generated model of the patient's root cavity is produced, for example, via an x-ray being analysed by suitable computer software, such as CAD. A laser-cutting machine or other suitable device, such as via a three-dimensional scanner, interfacing with the computer modelling equipment can then be utilised to produce the dental implant 12 from the inputted three-dimensional model. Although laser cutting is suggested, machining, electron, ion or laser beam melting or similar techniques could be utilised.

The abutment 14 may be a known element, and in this case typically comprises a base plate 34 having two male connectors 36 extending centrally and preferably coaxially in opposite directions. The male connectors 36 are preferably elongate bosses. The first male connector 38 is adapted for engagement within a complimentarily shaped abutment opening 40 formed typically substantially centrally in the top surface 28 of the base portion 20 of the implant body 18 such that the base plate 34 is seatable on the top surface 28. Preferably, a perimeter edge of the base plate 34 extends to or substantially to the perimeter edge of the top surface 28 of the base portion 20. However, the base plate 34 may under or overhang the top surface 28 of the base portion 20.

The prosthetic crown 16 is formed to substantially match the crown portion of the patient's tooth which has been removed, whilst including an opening 42 in its lower surface to receive the second male connector 44 of the abutment 14 as a complimentary fit.

The prosthetic tooth 10 can be inserted into a patient's mouth once the asymmetric root portion 24 and base portion 20 has been formed with minimal preparation of the patient's asymmetric root cavity. To prepare the patient's root cavity, a dental tool, preferably being an ultrasonic drill, is utilised which comprises an asymmetric abrasive vibratory head. Beneficially, the asymmetric abrasive vibratory head may be removable, which thus enables the option of a plurality of interchangeable differently-shaped asymmetric abrasive vibratory heads to be provided, if necessary. Such heads may be tripod, elliptical, irregular shaped cylindrical, figure of eight, or any other suitable asymmetric or irregular shape, as necessity dictates. These shapes thus allow drilling into the open root cavity to obtain the shape closest to the implant. Since the asymmetric root portion of the implant is already closely matching the shape of the patient's root cavity, minimal further preparation is required once an appropriately shaped head is selected for the tool.

The ultrasonic dental tool operates by conducting energy via vibrations into an abrasive medium which does the actual cutting or abrading. A head is typically releasably connected onto the end of a support. The support with the attached cutting/abrading head, threads into a transducer which converts an oscillating electrical current received from a power supply into vibrational energy at a frequency of typically around 20 KHz. These vibrations are conducted through the support into the head which is in contact with the target material, in this case being the interior of the open root cavity. The energy conducted to the head cause impact at the target area, wearing the root cavity surface into the same shape as the head.

Although preferably ultrasonic, the dental tool may use a mechanical vibratory mechanism instead of an ultrasonic vibratory mechanism.

The asymmetric root portion 24 can then be urged into the prepared root cavity preferably causing self-broaching or self-tapping via the engagement means 30, 32, and the abutment 14 and crown 16 can be provided thereon to complete the procedure.

However, the prosthetic tooth 10 can be preassembled prior to insertion into the patient's tooth cavity. Alternatively, the abutment 14 can be mounted on the base portion 20 of the dental implant 12, and this combination can be inserted into the patient's root cavity, with the prosthetic crown 16 being located on the abutment 14 thereafter.

The abutment opening 40 in the implant body 18 may have a non-circular lateral cross-section. In this case, the first male connector 36 of the abutment 14 also has a complimentary non-circular lateral cross-section. By utilising a multi-faceted lateral cross-sectional shape, specific indexing and adjustment of the abutment 14 relative to the implant body 18 can be undertaken. This is beneficial when the abutment 14 is asymmetric, thereby allowing the prosthetic crown 16 to be adjusted to better fit the shape of the patient's gum cavity and/or to better align with adjacent teeth.

The abutment 14 may be integrated as one-piece with the implant body 18, and in this case the abutment 14 may therefore also be asymmetric similarly to the root portion 24. In this arrangement, the abutment 14 can be formed simultaneously with the implant body 18 using the process described above.

It may also be feasible to integrally form the prosthetic crown 16 with the abutment 14. In this case, the abutment 14 may be integral with the implant body 18 or separate.

A selection of differently shaped dental implants 12 having different asymmetric root portions 24 can also be provided. In this case, a common abutment 14 and/or prosthetic crown 16 may be provided to fit each of the dental implants 12 with a common interface. This would be advantageous by allowing selection from a set of common or standard asymmetric root portions. The open root cavity would then be prepared to receive the selected asymmetric root portion. The root cavity may be prepared by a substantially complimentarily shaped broach or rasp, and/or by use of an ultrasonic cutting device.

Alternatively, the dental implant 12 may be formed as a bespoke unit. As above, the open root cavity may be prepared by a correspondingly shaped broach or rasp and/or by an ultrasonic cutting device to best receive the bespoke asymmetric implant.

Referring to FIGS. 3 and 4, and FIGS. 5 and 6, there is shown second and third embodiments respectively of a dental implant 12. Like references refer to like parts, and further detailed description is omitted. In these embodiments, the dental implant 12 includes an implant body 18 having a common base portion 20 and a plurality of spaced apart asymmetric root portions 24 extending therefrom. The engagement means 30, 32 is as described above, along with the options for the abutment 14 and the prosthetic crown 16. The second embodiment of FIGS. 3 and 4 has two asymmetric root portions 24 extending from the, preferably asymmetric, base portion 20, and the third embodiment of FIGS. 5 and 6 has four asymmetric root portions 24 extending from the, again preferably asymmetric, base portion 20.

In the above embodiments, the asymmetric root portion and the base portion preferably have a longitudinal extent so as to in use not extend above a gum line of the, typically asymmetric, open root cavity of the patient's mouth.

It is thus possible to provide a dental implant having at least an asymmetric root portion which matches or substantially matches a root cavity of a patient's mouth. The root cavity thus requires minimal preparation prior to the procedure. Preparation can be performed by a suitably shaped broach or rasp and/or by an ultrasonic cutting device. Due to the root portion being asymmetric, stability within the root cavity is substantially immediate, allowing a patient to use the prosthetic tooth much sooner following the procedure. It is also possible to integrally form the abutment as one-piece with the implant. It is further possible to provide a dental implant having one, two or four asymmetric root portions. Furthermore, the length of the dental implant can be predetermined so that seating of the prosthetic crown above the gum line does not occur. A set of common or standard asymmetric dental implants can be provided for selection of a close-matching fit. Conveniently, an ultrasonic cutting device can then be used to prepare the open root cavity to receive the asymmetric root portion of the selected implant. Similarly, the ultrasonic cutting device can be used to quickly prepare the root cavity to receive a bespoke formed asymmetric root portion.

The embodiments described above are provided by way of examples only, and further modifications will be apparent to persons skilled in the field without departing from the scope of the invention as defined by the appended claims.

1. A dental implant system, comprising a plurality of selectable different dental implants; an abutment formed on or engageable with each said dental implant; and a common prosthetic crown formed on or engageable with the abutment, each said dental implant having an implant body having an asymmetric root portion receivable in an asymmetric open root cavity and engagement means on the asymmetric root portion to at least in part engage a surface of the root cavity, the asymmetric root portion being complementarily shaped to fit the said asymmetric open root cavity, each root portion being asymmetric in two mutually perpendicular lateral extents along a longitudinal axis of the root portion, an outer surface of each implant body being non-smoothly undulating along the longitudinal extent of the implant body; and the engagement means including: a plurality of spaced apart discontinuous lateral projections which extend from an exterior surface of the asymmetric root portion, and a rough textured surface.

2.-6. (canceled)

7. The dental implant system as claimed in claim 1, wherein the said lateral projections are at least one of elongate ribs and fins along at least a majority of a longitudinal extent of the root portion.

8. The dental implant system as claimed in claim 1, wherein a lateral extent of the lateral projection is substantially uniform along at least a majority of a longitudinal extent of the lateral projection.

9. (canceled)

10. The dental implant system as claimed in claim 1, wherein the rough textured surface is integrally formed as one-piece with the root portion.

11. The dental implant system as claimed in claim 1, wherein the rough textured surface is formed as a layer on an exterior surface of the root portion.

12. The dental implant system as claimed in claim 1, further comprising an outer coating of a biocompatible fixation material.

13. The dental implant system as claimed in claim 1, wherein the said lateral projections have non-truncated crests forming self-broaching elements.

14.-16. (canceled)

17. The dental implant system as claimed in claim 1, wherein the implant body includes a base portion from which the said asymmetric root portion extends, the abutment being integrally formed as one-piece with the base portion.

18. The dental implant system as claimed in claim 1, wherein the abutment is asymmetric in two mutually perpendicular lateral extents along a longitudinal axis of the abutment.

19-20. (canceled)

21. The dental implant system as claimed in claim 1, wherein the prosthetic crown is integrally formed as one-piece with the abutment.

22-23. (canceled)

24. The dental implant system as claimed in claim 21, wherein the abutment is integrally formed as one-piece with each of the plurality of selectable dental implants, each abutment including a common connector with the prosthetic crown.

25. A method of fitting a dental implant as claimed in claim 1, the method comprising the steps of: forming a three-dimensional computer-generated model of a root cavity of a patient's mouth; selecting a dental implant from the said plurality of selectable different dental implants, wherein each dental implant of the plurality having a different root portion being asymmetric in two mutually perpendicular lateral extents along the longitudinal axis of the root portion; preparing the root cavity to be complementarily asymmetric in two mutually perpendicular lateral extents along the longitudinal axis of the root cavity so as to accept the selected dental implant as a substantially complementary fit; and inserting the selected dental implant and an abutment formed thereon or engageable therewith into the open root cavity of a patent's mouth.

26-27. (canceled)

28. The method as claimed in claim 25, wherein a prosthetic crown is located on the abutment following installation.

29-30. (canceled)

31. The method as claimed in claim 25, wherein the open root cavity is prepared using at least one of a broach and rasp shaped to at least substantially correspond to the selected preformed asymmetric root portions.

32. (canceled)

33. The method as claimed in claim 25, wherein the open root cavity is prepared using an ultrasonic cutting device having two mutually perpendicular asymmetric lateral extents along a longitudinal axis of the ultrasonic cutting device.

34. A dental tool having an asymmetric abrasive vibratory head to prepare an open root cavity to receive a dental implant as claimed in claim 1, the asymmetric abrasive vibratory head being asymmetric in two mutually perpendicular lateral extents along a longitudinal axis of the asymmetric abrasive vibratory head.

35. (canceled)

36. The dental tool as claimed in claim 34, wherein a plurality of interchangeable differently-shaped said asymmetric abrasive vibratory heads are provided.

37. The dental tool as claimed in claim 34, wherein the tool is an ultrasonic drill.

38. The dental implant system as claimed in claim 1, wherein the said lateral projections have non-truncated outer edges forming self-broaching elements.
